(19) United States
(12) Patent Application Publication
(10) Pub. No.: US 2026/0210801 A1
(43) Pub. Date: Jul. 23, 2026

(54) METHOD FOR DETERMINING THE INVERSION STATE OF A SOFT CONTACT LENS

(71) Applicant: Alcon Inc., Fribourg (CH)

(72) Inventors: Daniel Paulus, Miltenberg (DE); Irina Hoffmann, Darmstadt (DE); Thomas Keleschovsky, Gelnhausen (DE); Volker Lanig, Giebelstadt (DE); Felix Finkenbein, St. Leon-Rot (DE)

(21) Appl. No.: 19/453,156

(22) Filed: Jan. 20, 2026

Related U.S. Application Data
(60) Provisional application No. 63/747,623, filed on Jan. 21, 2025.

(51) Int. Cl. G01M 11/08

(52) U.S. Cl. CPC G01M 11/08

(57) ABSTRACT

A method for determining the inversion state of a soft contact lens which is arranged in an interior space of an inspection cuvette comprises the steps of: through the viewing glass obtaining a dark-field image of the soft contact lens arranged in the interior space along the optical axis; identifying a lens edge of the soft contact lens in the dark-field image; determining one characteristic values representative of the brightness of a portion of the lens edge in the dark-field image; comparing one of the characteristic values with a corresponding predetermined threshold value; and determining that the soft contact lens is inverted in case the characteristic values is equal to or above the corresponding predetermined threshold value.

The present invention generally relates to the inspection of soft contact lenses, and more particularly relates to a method for determining the inversion state of a soft contact lens which is arranged in an interior space of an inspection cuvette.

Soft contact lenses which are worn only once and are disposed of after use are produced in fully automated production lines. The soft contact lenses produced by such production lines must be inspected prior to being placed in a primary packaging shell into which a storage/preservation solution is dispensed and which is then sealed by a cover foil. Inspection of the soft contact lens prior to placing them into the primary packaging shell is vital in order to make sure the soft contact lenses meet the desired specifications and are free of defects.

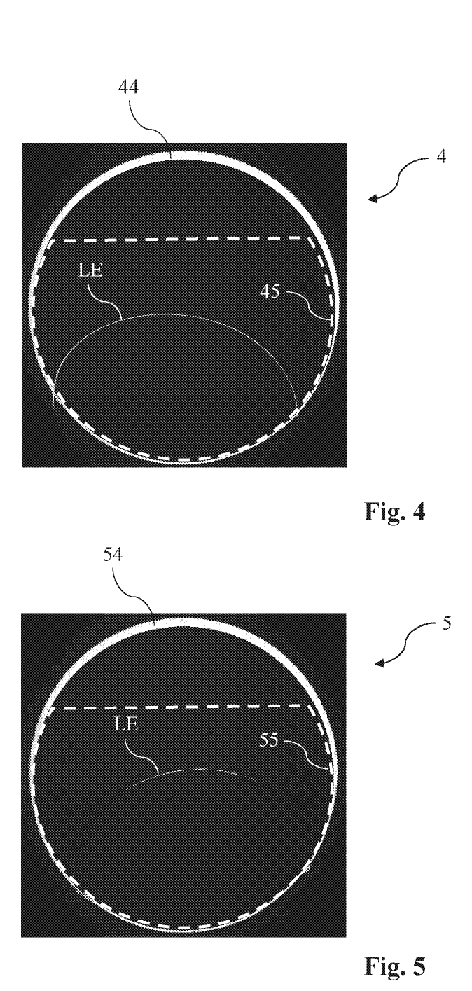

In some embodiments of such production lines, inspection of the soft contact lenses is performed in inspection cuvettes. Such an inspection cuvette typically comprises an interior space in which a liquid (e.g. water) is contained in which the soft contact lens is immersed. An inspection cuvette that may be used for this purpose is disclosed, for example, in WO 03/016855 A1. The cuvette shown there is pivotally arranged about a pivot axis for being positioned either in an inspection position (see FIG. 3 of WO 03/016855) in which the soft contact lens is inspected for defects, or in a handling position (see FIG. 4 of WO 03/016855) in which the soft contact lens can be inserted into and removed from the interior space of the cuvette.

The inspection cuvette comprises a bottom glass (which may be embodied as a bottom lens) forming a lower boundary of the interior space of the cuvette. The bottom glass has a concave inner surface for the soft contact lens to rest on. This concave inner surface of the bottom glass of the inspection cuvette faces towards the interior space of the cuvette.

The inspection cuvette further comprises a flat top viewing glass forming an upper boundary of the interior space. The flat top viewing glass is arranged such that an optical axis running normal to the flat top viewing glass also runs through the center of the concave inner surface of the bottom glass (or bottom lens).

The inspection cuvette further comprises a handling channel which is connected at a first end thereof with the interior space of the cuvette. At a second end thereof, the handling channel comprises a handling opening. The soft contact lens can be inserted into and removed from the interior space of the inspection cuvette through the handling opening and the handling channel. Insertion of the soft contact lens into and removal of the soft contact lens from the interior space of the inspection cuvette may be performed, for example, with the aid of a gripper.

During insertion of the soft contact lens into the cuvette, i.e. when the inspection cuvette is in the handling position, the gripper with the soft contact lens adhered thereto is moved through the handling opening and through the handling channel into the liquid contained in the interior space of the inspection cuvette. The soft contact lens is then released from the gripper (e.g. through the application of overpressure or through termination of suction applied through the gripper), and the released soft contact lens then travels downwards in the liquid until it reaches the bottom glass to rest on the concave inner surface of the bottom glass. Thereafter, the cuvette is pivoted into the inspection position in which inspection of the soft contact lens is performed. Various inspection stations may be arranged in an inspection module of such a production line one after the other, and the cuvettes - each containing a soft contact lens - are transported through the various inspection stations.

In case during inspection it is detected that the soft contact lens is inverted, the inspection stations may comprise a lens re-inversion station in which the soft contact lens is re-inverted back to its proper non-inverted state. For re-inversion of the soft contact lens, the cuvette is pivoted to the handling position in which the soft contact lens is re-inverted, and is subsequently pivoted back to the inspection position again for further inspection.

Inversion of the soft contact lens may occur at various occasions during the lens manufacturing process so that an already inverted soft contact lens may be transferred into the inspection cuvette, even though the inversion state of the soft contact lens does not change through the lens transfer itself. Also, a non-inverted soft contact lens may inadvertently get inverted through the transfer of the non-inverted soft contact lens into the inspection cuvette. For example, during removal of the soft contact lens from a tube-shaped container in which the soft contact lens is transported through one or more liquid baths (e.g. of a lens treatment module) and the subsequent insertion of the soft contact lens into the inspection cuvette using certain types of transfer grippers (such as, for example, the gripper disclosed in WO 2012/066060), the soft contact lens may inadvertently get inverted. Even in case a non-inverted soft contact lens is inserted into the liquid contained in the inspection cuvette, the soft contact lens may inadvertently get inverted during the subsequent travel of the soft contact lens down to the bottom glass. Still further, during the movement of the inspection cuvette through the various inspection stations, a non-inverted soft contact lens may be swirled up in the liquid and may inadvertently get inverted during its travel down to the bottom glass of the inspection cuvette. Yet further, during the pivotal movement of the inspection cuvette (between the handling position and the inspection position, or vice versa) a non-inverted soft contact lens may be swirled up in the liquid and may inadvertently get inverted and may settle down in the inverted state. As is evident, there may be many reasons why the soft contact lens may be in the inverted state in the inspection cuvette.

Inversion of a soft contact lens is generally unwanted, but in particular it is unwanted that an inverted soft contact lens be placed into a primary packaging shell and distributed to the user in the inverted state, since the user may then pick the inverted lens from the primary packaging shell and place the inverted soft contact lens on the eye which may at least cause user dissatisfaction. In particular during the inspection of toric soft contact lenses, inadvertent inversion of the toric soft contact lenses contact lenses may occur a little more frequently than during the inspection of rotationally symmetrical soft contact lenses.

Unfortunately, the inversion state of a soft contact lens is typically not determined in the very last inspection station of an inspection module, but is typically determined prior to inspection of the soft contact lens for other defects, or prior to the determination of the refractive power of the soft contact lens or the measurement of the center thickness of the soft contact lens. Even assuming that the inversion state is determined in the very last inspection station of an inspection module (i.e. while the inspection cuvette is in the inspection position), it is still necessary to subsequently pivot the inspection cuvette into the handling position in order to be able to remove the soft contact lens from the inspection cuvette (e.g. with the aid of a gripper) and to transfer it to the primary packaging shell. However, during this pivotal movement of the inspection cuvette into the handling position, an inadvertent inversion of the soft contact lens may occur again which remains undetected so that an inverted soft contact lens may then be placed into the primary packaging shell.

Another reason why the soft contact lens may end up in the inverted state at the very last inspection station of the inspection module is that even in case an inverted lens detection station is present in the inspection module and properly determines that the contact lens is inverted, the inverted soft contact lens may not be properly re-inverted to the non-inverted state in a subsequent lens re-inversion station. Also, in case the inverted lens detection station wrongly determines a non-inverted soft contact lens to be inverted, the non-inverted soft contact lens may erroneously be re-inverted to the inverted state in the subsequent lens re-inversion station (due to the wrong determination). Whatever the reason is, there may be occurrences where the soft contact lens is in the inverted state at the very last inspection station (i.e. at the time of being ready for being placed into a primary packaging shell).

It is therefore an object of the present invention to avoid that an inverted soft contact lens be placed into a primary packaging shell to the greatest extent possible.

This object is achieved by the method according to the invention as it is specified in the independent claim. Advantageous aspects of the method according to the invention are the subject of the dependent claims.

In particular, the subject of the invention is a method for determining the inversion state of a soft contact lens which is arranged in an interior space of an inspection cuvette and which is immersed in a liquid contained in the interior space of the inspection cuvette. The inspection cuvette is pivotally arranged about a pivot axis for being positioned either in an inspection position in which the soft contact lens is inspected, or in a handling position in which the soft contact lens can be inserted into and removed from the interior space of the inspection cuvette. The inspection cuvette comprises - a bottom glass forming a lower boundary of the interior space, the bottom glass having a concave inner surface for the soft contact lens to rest on, the concave inner surface facing towards the interior space; - a flat top viewing glass forming an upper boundary of the interior space, the flat top viewing glass being arranged such that an optical axis running normal to the flat top viewing glass runs through the center of the concave inner surface of the bottom glass; and - a handling channel which is connected at a first end thereof with the interior space, and at a second end thereof comprises a handling opening for insertion of the soft contact lens into and removal of the soft contact lens from the interior space through the handling opening and the handling channel. The method comprises the steps of - positioning the inspection cuvette in the handling position; - through the viewing glass obtaining a dark-field image of the soft contact lens arranged in the interior space along the optical axis; - identifying a lens edge of the soft contact lens in the dark-field image; - determining one or more characteristic values representative of the brightness of at least a portion of the lens edge in the dark-field image; - comparing at least one of the one or more characteristic values with a corresponding predetermined threshold value; and - determining that the soft contact lens is inverted in case the at least one of the one or more characteristic values is equal to or above the corresponding predetermined threshold value; or - determining that the soft contact lens is not inverted in case the at least one of the one or more characteristic values is below the corresponding predetermined threshold value. In accordance with an advantageous aspect of the method according to the invention, the step of determining the one or more characteristic values representative of the brightness of at least a portion of the identified lens edge in the dark-field image comprises determining a mean brightness value of substantially the whole lens edge in the dark-field image, and the step of comparing the at least one of the one or more characteristic values with a corresponding predetermined threshold value comprises comparing the mean brightness value with a predetermined mean brightness threshold value.

According to a further advantageous aspect of the method according to the invention, the step of determining the one or more characteristic values representative of the brightness of at least a portion of the lens edge in the dark-field image comprises - determining a central mean brightness value of a central portion of the lens edge; - determining a first peripheral mean brightness value of a first peripheral portion of the lens edge and a second peripheral mean brightness value of a second peripheral portion of the lens edge, the first peripheral portion and the second peripheral portion being located at opposite sides of the central portion of the lens edge; - determining a peripheral mean brightness value by averaging the first peripheral mean brightness value and the second peripheral mean brightness value, and - determining a differential mean brightness value by subtracting the central mean brightness value from the peripheral mean brightness value; and the step of comparing the at least one of the one or more characteristic values with a corresponding predetermined threshold value comprises - comparing the differential mean brightness value with a predetermined differential mean brightness threshold value. Yet in accordance with a further advantageous aspect of the method according to the invention, both the mean brightness value of substantially the whole lens edge in the dark-field image as well as the differential mean brightness value are determined and compared with the predetermined mean brightness threshold value and the predetermined differential mean brightness threshold value, respectively. The soft contact lens is then determined as being inverted in case either the mean brightness value of substantially the whole lens edge is equal to or above the predetermined mean brightness threshold value or the differential mean brightness value is equal to or above the predetermined differential mean brightness threshold value, or both.

In accordance with a further advantageous aspect of the method according to the invention, the step of determining the one or more characteristic values representative of the brightness of at least a portion of the identified lens edge in the dark-field image comprises determining a mean brightness value of substantially the whole lens edge in the dark-field image. The step of determining the one or more characteristic values representative of the brightness of at least a portion of the lens edge in the dark-field image further comprises - determining a central mean brightness value of a central portion of the lens edge; - determining a first peripheral mean brightness value of a first peripheral portion of the lens edge and a second peripheral mean brightness value of a second peripheral portion of the lens edge, the first peripheral portion and the second peripheral portion being located at opposite sides of the central portion of the lens edge; - determining a peripheral mean brightness value by averaging the first peripheral mean brightness value and the second peripheral mean brightness value, and - determining a differential mean brightness value by subtracting the central mean brightness value from the peripheral mean brightness value; and wherein the step of comparing (63) the at least one of the one or more characteristic values with a corresponding predetermined threshold value comprises - comparing the determined differential mean brightness value with a predetermined combined differential mean brightness threshold value which is linearly dependent from the determined mean brightness value. Still in accordance with another aspect of the method according to the invention, the step of identifying the lens edge of the soft contact lens in the dark-field image comprises segmentation of the lens edge in the dark-field image.

Further in accordance with another aspect of the method according to the invention, the step of identifying the lens edge in the dark-field image comprises determining an area in the dark-field image where the lens edge is expected to be located, and further comprises determining in the said area where the lens edge is expected to be located a plurality of individual regions of interest for each of which the location of maximum brightness within the respective individual region of interest is determined. The location of maximum brightness within the respective individual region of interest represents a pixel of the lens edge in the dark-field image.

According to another aspect of the method according to the invention, the area in the dark-field image where the lens edge is expected to be located has the shape of a fan. The fan comprises a plurality of rectangles arranged side by side in a manner such that the longitudinal sides of the individual rectangles of the plurality of rectangles extend in a radial direction of the fan. Each of the individual rectangles of the plurality of rectangles represents a said individual region of interest.

In accordance with a further aspect of the method according to the invention, the location of maximum brightness within the respective individual rectangle representing the individual region of interest is determined to represent a pixel of the lens edge only in case a lens edge transition is detected within the individual rectangle in the radial direction adjacent to the location of maximum brightness representing the pixel of the lens edge.

According to another aspect of the method according to the invention, the method further comprises the steps of - segmenting the outer boundary of the bottom glass of the inspection cuvette in the dark-field image, and - excluding from the determination of the one or more characteristic values representative of the brightness of the at least one portion of the lens edge in the dark-field image all portions of the lens edge which are located on the outer boundary of the bottom glass of the inspection cuvette. According to still another aspect of the method according to the invention, the method further comprises the steps of - through the viewing glass obtaining a telecentric bright-field image of the soft contact lens arranged in the interior space along the optical axis; - identifying the lens edge of the soft contact lens in the telecentric bright-field image; - registering the telecentric bright-field image of the soft contact lens and the dark-field image of the soft contact lens; and - in the registered dark-field image of the soft contact lens determining the area where the lens edge is expected to be located by determining the plurality of individual regions of interest at those locations in the dark-field image that correspond to the locations in the registered telecentric bright-field image where the lens edge of the soft contact lens has been identified.

According to yet another aspect of the method according to the invention, the step of identifying the lens edge of the soft contact lens in the telecentric bright-field image comprises segmentation of the lens edge in the telecentric bright-field image.

In accordance with a further aspect of the method according to the invention, the step of determining the one or more characteristic values representative of the brightness of at least a portion of the identified lens edge in the dark-field image comprises determining a mean brightness value of substantially the whole lens edge in the dark-field image, and the step of comparing at least one of the one or more characteristic values with the corresponding predetermined threshold value comprises comparing the mean brightness value with a first predetermined mean brightness threshold value. The step of determining the one or more characteristic values representative of the brightness of at least a portion of the lens edge in the dark-field image further comprises - determining a central mean brightness value of a central portion of the lens edge; - determining a first peripheral mean brightness value of a first peripheral portion of the lens edge and a second peripheral mean brightness value of a second peripheral portion of the lens edge, the first peripheral portion and the second peripheral portion being located at opposite sides of the central portion of the lens edge; - determining a peripheral mean brightness value by averaging the first peripheral mean brightness value and the second peripheral mean brightness value, and - determining a differential mean brightness value by subtracting the central mean brightness value from the peripheral mean brightness value. And the step of comparing the at least one of the one or more characteristic values with the corresponding predetermined threshold value comprises - comparing the differential mean brightness value with a predetermined differential mean brightness threshold value. The soft contact lens is then determined as being inverted in case - either the mean brightness value of substantially the whole lens edge is equal to or above the predetermined first mean brightness threshold value, - or the mean brightness value of substantially the whole lens edge is equal to or above a predetermined second mean brightness threshold value lower than the first predetermined mean brightness threshold value and the differential mean brightness value is equal to or above the predetermined differential mean brightness threshold value, - or both. In another aspect, the method according to the invention further comprises the steps of - through the viewing glass obtaining a diffuse bright-field image of the soft contact lens arranged in the interior space along the optical axis; - identifying the lens edge of the soft contact lens in the diffuse bright-field image; - registering the diffuse bright-field image of the soft contact lens and the dark-field image of the soft contact lens; - in the registered dark-field image of the soft contact lens determining the area where the lens edge is expected to be located by determining the plurality of individual regions of interest at those locations in the dark-field image that correspond to the locations in the registered diffuse bright-field image where the lens edge of the soft contact lens has been identified.

In accordance with yet a further aspect of the method according to the invention, the soft contact lens is a toric soft contact lens, in particular a toric soft contact lens having a posterior surface having a toric geometry and having an anterior surface comprising features for rotationally stabilizing the soft contact lens on the eye at a predetermined orientation.

The method according to the invention has a number of advantages. First of all and very importantly, it is performed with the inspection cuvette being in the handling position rather than in the inspection position. That is to say, once the determination is made whether or not the soft contact lens is inverted, the inspection cuvette does not have to be pivoted anymore prior to removal of the soft contact lens from the inspection cuvette. Accordingly, if the soft contact lens has been determined as not being inverted it can be removed from the inspection cuvette by a gripper and transferred to the primary packaging shell without the risk of getting inadvertently inverted before, as the inspection cuvette is already in the handling position in which these actions can be performed. This avoids the risk of the soft contact lens getting inverted due to pivoting the inspection cuvette from the inspection position into the handling position after the inversion state of the soft contact lens has been determined.

Surprisingly, it has been found that the brightness of the lens edge (or at least a portion thereof) in a dark-field image can be used to make such determination when the inspection cuvette is in the handling position. To be able to analyze the brightness of the lens edge (or at least a portion thereof), in a first step the lens edge must be identified in the dark-field image. Different methods may be used for identifying the lens edge in the dark-field image, as will be discussed in more detail below. Once the lens edge has been identified in the dark-field image, one or more characteristic values representative of the brightness of at least a portion of the lens edge is determined and compared with a corresponding predetermined threshold value. In case this at least one of the one or more characteristic values is equal to or above the corresponding predetermined threshold value the soft contact lens is determined as being inverted, whereas the soft contact lens is determined as not being inverted in case this at least one of the one or more characteristic values is below the predetermined threshold value. Also, it is possible that at least one of the one or more characteristic values is above its corresponding predetermined threshold value (being indicative of an inverted soft contact lens) while at least another one of the one or more characteristic values is below its corresponding threshold value (also being indicative of an inverted soft contact lens). A respective predetermined threshold value to which a respective characteristic value of the one or more characteristic values is compared may be established by evaluating a significant number of soft contact lenses (e.g. a few hundred) of the type to be produced the inversion state of which is known. The predetermined threshold value for the respective characteristic value is then established to be a value that allows to make a determination of the inversion state with a very low percentage of false determinations (in any event less than 10%, typically less than 5%, even more typically less than 3%, and preferably less than 2%). The thus established predetermined threshold value for the respective characteristic value is then used for making the determination of the inversion state of the soft contact lenses during production, i.e. when the inversion state of the soft contact lenses is not known. The predetermined threshold value may be a fixed value (e.g. a fixed gray scale value), but may also be a value that is linearly dependent from a determined actual characteristic value of the soft contact lens, as will be discussed further below. In case a soft contact lens has been determined as not being inverted (i.e. properly oriented) it can be removed from the inspection cuvette by a gripper and transferred into a primary packaging shell without the risk of the soft contact lens getting inverted, as the inspection cuvette is in the handling position already.

As is mentioned above, at least one of the one or more characteristic values representative of the brightness of at least a portion of the lens edge in the dark-field image must be determined in order to be able to make a determination as to whether or not the soft contact lens is inverted.

One option for obtaining at least one of the one or more characteristic values is to determine a mean brightness value of substantially the whole lens edge in the dark-field image. This mean brightness value is then compared with a predetermined mean brightness threshold value to make the determination as to whether or not the soft contact lens is inverted (this predetermined mean brightness threshold value typically being a fixed value). In this regard, the term 'substantially the whole lens edge' means that portions of the lens edge that overlap, interfere with or are outside the boundary of the bottom glass of the inspection cuvette are not used to determine the said mean brightness value. This option is based on the observation that the mean brightness of the lens edge is above a certain predetermined mean brightness threshold value in case the soft contact lens is inverted. More frankly speaking, this means that the mean brightness of the lens edge of an inverted soft contact lens is significantly higher than the mean brightness of the lens edge of a non-inverted soft contact lens. Selecting a suitable predetermined mean brightness threshold value thus allows to distinguish inverted soft contact lenses (mean brightness of the lens edge is equal to or above the predetermined mean brightness threshold value) from non-inverted soft contact lenses (mean brightness of the lens edge is below the predetermined mean brightness threshold value). This option aims at identifying inverted soft contact lenses having a more or less continuous high brightness along the lens edge.

Another option for obtaining the one or more characteristic values is to analyze different portions of the lens edge in the dark-field image. According to this option, a central mean brightness value of a central portion of the lens edge is determined. In addition, a first peripheral mean brightness value of a first peripheral portion of the lens edge and a second peripheral mean brightness value of a second peripheral portion of the lens edge are determined. The first peripheral portion of the lens edge and the second peripheral portion of the lens edge are located at opposite sides of the central portion of the lens edge. These first and second peripheral mean brightness values are then averaged to determine a peripheral mean brightness value. Once this peripheral mean brightness value has been determined, a differential mean brightness value is determined by subtracting the central mean brightness value from the peripheral mean brightness value. This differential mean brightness value is then compared with a predetermined differential mean brightness threshold value (this predetermined differential mean brightness threshold value typically being a fixed value). In case the differential mean brightness value is equal to or above the predetermined differential mean brightness threshold value the soft contact lens is determined as being inverted, whereas in case the differential mean brightness value is below the predetermined differential mean brightness threshold value the soft contact lens is determined as not being inverted (i.e. as being properly oriented). This option is based on the observation, that for inverted soft contact lenses the peripheral portions of the lens edge have a mean brightness that is significantly above the mean brightness of a central portion of the lens edge, whereas for non-inverted soft contact lenses this is not the case. Selecting a suitable differential mean brightness threshold value thus allows to distinguish inverted soft contact lenses from non-inverted soft contact lenses. This option aims at identifying inverted soft contact lenses having a higher brightness in the peripheral portions of the lens edge than in the central portion.

It is also possible to use both afore-described options in combination, i.e. determining the mean brightness value of substantially the whole lens edge and comparing it with a predetermined mean brightness threshold value as well as determining the differential mean brightness value and comparing it with a predetermined differential mean brightness threshold value, respectively. In case one of these determinations (or both) lead to the determination that the soft contact lens is inverted, the soft contact lens is determined as being inverted. This option provides for an increased safety as regards an unwanted transfer of an inverted soft contact lens into a primary packaging shell.

As an alternative to using fixed values for the predetermined mean brightness threshold value and the predetermined differential mean brightness threshold value, it is possible to use a combined differential mean brightness threshold value. The term 'combined' used in this regard is to denote that this 'combined' differential mean brightness value is not a fixed threshold value but rather is a threshold value for the differential mean brightness that varies and depends from (and therefore is 'combined' with) the determined mean brightness value. More particularly, this predetermined combined differential mean brightness threshold value is linearly dependent from the determined mean brightness value (or to say it in other words: The graph of the predetermined 'combined' differential mean brightness threshold value in an x-y diagram in which the differential mean brightness value is shown on the ordinate y and in which the mean brightness value is shown on the abscissa x is a straight line having a predetermined slope). The lower the value for the mean brightness value is (i.e. the lower the mean brightness of the lens edge in the dark-field image is), the higher is the predetermined combined differential mean brightness threshold value (i.e. the larger the difference between the mean brightness of the peripheral portions of the lens edge from the mean brightness of the central portion of the lens edge must be). In such instance, only one comparison is to be performed, namely the comparison of the (actual) determined differential mean brightness value with the predetermined 'combined' differential mean brightness threshold value, however, this threshold value to which the (actual) determined differential mean brightness value is to be compared depends on the (actual) determined mean brightness value.

As already mentioned, different methods are possible for identifying the lens edge in the dark-field image. One possible method for identifying the lens edge is segmentation of the lens edge in the dark-field image. Suitable segmentation techniques are known in the art. With the aid of segmentation techniques not all portions of the dark-field image have to be analyzed (and the related data processed), but rather only those portions in the dark-field image which are in the region of the lens edge must be analyzed (and the corresponding data processed). This renders the method according to the invention more efficient.

According to another method for identifying the lens edge in the dark-field image, an area is determined in the dark-field image where the lens edge is expected to be located. In the said area where the lens edge is expected to be located, a plurality of individual regions of interest is determined for each of which the location of maximum brightness within the respective individual region of interest is determined. This location of maximum brightness within the respective individual region of interest represents a pixel of the lens edge in the dark-field image. The determination of the area where the lens edge is expected to be located may be based on a plurality of previous dark-field images of soft contact lenses in the inspection cuvette when the inspection cuvette is in the handling position. In one embodiment the area of interest has the shape of a fan that comprises a plurality of rectangles that extend in the radial direction of the fan, and each of the rectangles represents one individual region of interest in which the location of maximum brightness is determined. An additional improvement may involve the detection of a lens edge transition within the individual rectangle in a radial direction adjacent to the location of maximum brightness. A lens edge transition may be detected when the brightness significantly decreases in the radial direction adjacent to the location of maximum brightness in the individual rectangle, so that the presence of a pixel of the lens edge at the location of maximum brightness is further confirmed by the detection of such lens edge transition.

The boundary of the bottom glass (or the bottom lens) of the inspection cuvette typically also appears as a bright (boundary) line in the dark-field image. However, pixels located on this bright (boundary) line are not representative of the brightness of the edge of the soft contact lens, even though portions of the lens edge may overlap with the boundary of the bottom glass. However, at such locations in the dark-field image the overall brightness may comprise contributions originating from both the boundary of the bottom glass and the lens edge, so that these locations must be excluded from the analysis. This can be achieved by segmentation of the boundary of the bottom glass, and by excluding all portions of the lens edge which are located on the boundary of the bottom glass from the determination of the one or more characteristic values representative of the brightness of the lens edge, which in turn is used for the determination of the inversion state of the soft contact lens.

The area in the dark-field image where the lens edge is expected to be located can be further determined with the aid of an additional telecentric bright-field image of the soft contact lens. The lens edge of the soft contact lens can be conveniently and reliably identified in the telecentric bright-field image. However, in order to be able to use the information on the location of the lens edge in the telecentric bright-field image to determine in the dark-field image the area where the lens edge is expected to be located, it is necessary to register the telecentric bright-field image and the dark-field image (both as regards size and orientation). After registration, the plurality of individual regions of interest are determined at those locations in the registered dark-field image that correspond to the locations where the lens edge has been identified in the registered telecentric bright-field image. And while both additionally obtaining a telecentric bright-field image as well as registration of the telecentric bright-field image and the dark-field image constitute an additional expense, these measures may be helpful in further decreasing the size of the area where the lens edge is expected to be located in the registered dark-field image, and they may also be helpful in identifying the lens edge more quickly and reliably in the registered dark-field image. By way of example, identifying the lens edge of the soft contact lens in the telecentric bright-field image may comprise segmentation of the lens edge in the telecentric bright-field image.

In the afore-described embodiments where both a telecentric bright-field image and a dark-field image of the soft contact lens are available, the determination of the inversion state of the soft contact lens may deviate in some aspects from the above-described options. Similar to what has been described above, a mean brightness value of substantially the whole lens edge in the dark-field image is determined and compared with a first predetermined mean brightness threshold value. Also, a central mean brightness value of a central portion of the lens edge is determined, and first and second peripheral mean brightness values are determined for first and second peripheral portion of the lens edge. These first and second peripheral mean brightness values are averaged to obtain a peripheral mean brightness value. A differential mean brightness value is then determined by subtracting the central mean brightness value from the central mean brightness value, and the so obtained differential mean brightness value is then compared with a predetermined differential mean brightness value. So far there is no difference to what has been described above. The difference is the manner how the inversion state of the soft contact lens is determined. The soft contact lens is determined to be inverted in case the mean brightness value of substantially the whole lens edge is equal to or above the predetermined first mean brightness threshold value. This is still not different from what is described above. However, alternatively the soft contact lens is determined to be inverted in case the mean brightness value of substantially the whole lens edge is equal to or above a predetermined second mean brightness threshold value that is lower than the first predetermined mean brightness threshold value, and in addition the differential mean brightness value is equal to or above the predetermined differential mean brightness threshold value. This means, that in addition to the differential mean brightness value being above a predetermined differential mean brightness threshold value a further criterion must be fulfilled to determine that the soft contact lens is inverted, and this further criterion is that the mean brightness value of substantially the whole lens edge must concurrently be above the predetermined second mean brightness threshold value. Of course, the soft contact lens is also determined as being inverted when both of the afore-mentioned alternatives concurrently lead to the determination that the soft contact lens is inverted.

As an alternative to using the telecentric bright-field image for additionally determining the area where the lens edge is expected to be located, a diffuse bright-field image of the soft contact lens may be used. The lens edge of the soft contact lens can then be conveniently and reliably identified in the diffuse bright-field image. However, also in this case, in order to be able to use the information on the location of the lens edge in the telecentric bright-field image to determine in the dark-field image the area where the lens edge is expected to be located, it is necessary to register the diffuse bright-field image and the dark-field image (both as regards size and orientation). After registration, the plurality of individual regions of interest are determined at those locations in the registered dark-field image that correspond to the locations where the lens edge has been identified in the registered telecentric bright-field image, as this has been described above in connection with the telecentric bright-field image. And while both additionally obtaining a diffuse bright-field image as well as registration of the diffuse bright-field image and the dark-field image constitute an additional expense, these measures may be helpful in further decreasing the size of the area where the lens edge is expected to be located in the registered dark-field image, and they may also be helpful in identifying the lens edge more quickly and reliably in the registered dark-field image. By way of example, identifying the lens edge of the soft contact lens in the diffuse bright-field image may comprise segmentation of the lens edge in the diffuse bright-field image.

Further advantageous aspects of the method according to the invention become evident from the following description of embodiments of the method according to the invention with the aid of the drawings, in which:

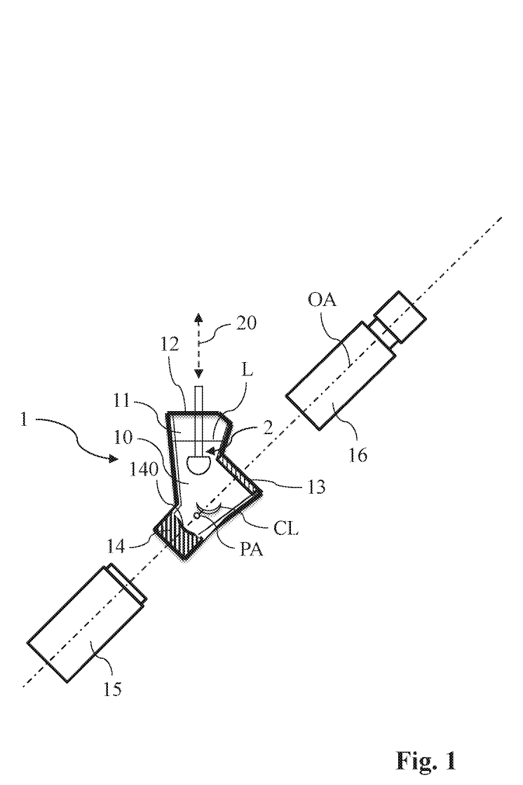

FIG. 1 shows an embodiment of some essential components of an apparatus for carrying out the method according to the invention, with the inspection cuvette arranged in the handling position;

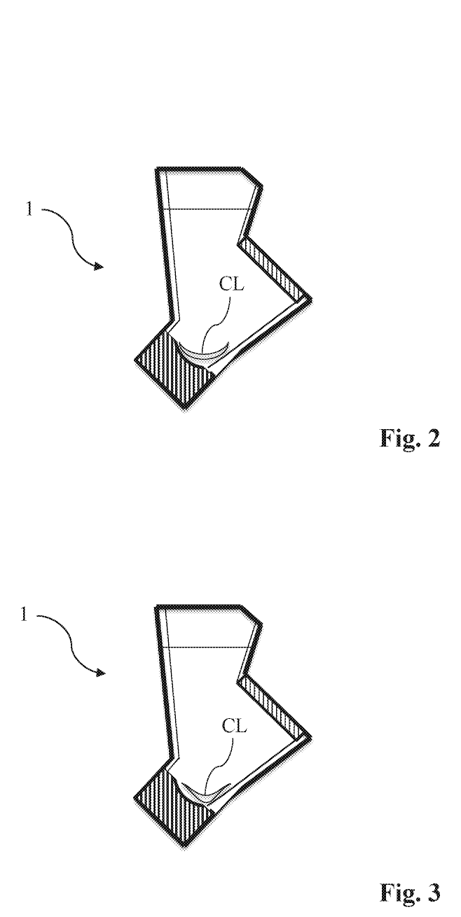

FIG. 2 shows the inspection cuvette of FIG. 1 (enlarged), with a non-inverted soft contact lens arranged therein;

FIG. 3 shows the inspection cuvette of FIG. 1 (enlarged), with an inverted soft contact lens arranged therein;

FIG. 4 shows a dark-filed image of an inverted soft contact lens;

FIG. 5 shows a dark-field image of a non-inverted soft contact lens;

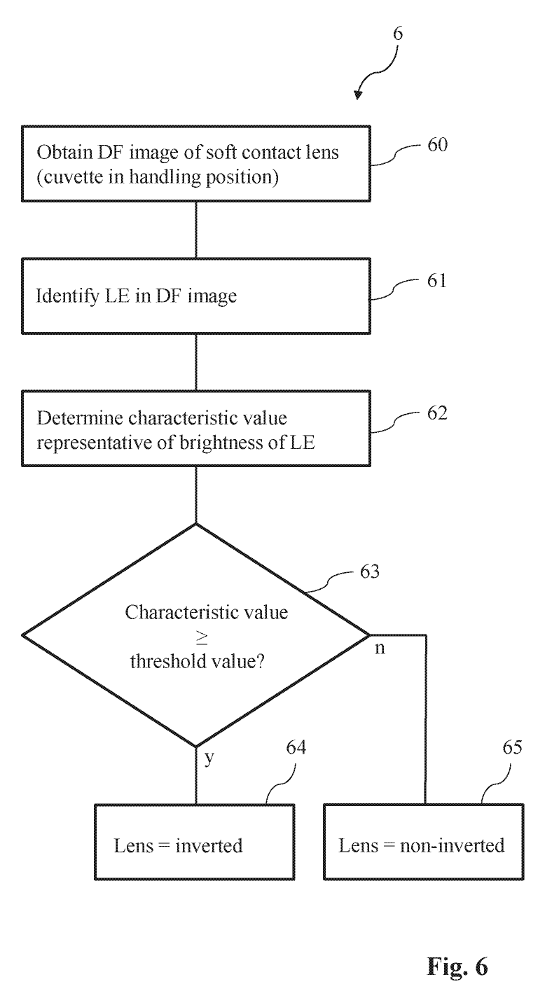

FIG. 6 shows a flow chart representing essential steps of the method according to the invention in a general manner;

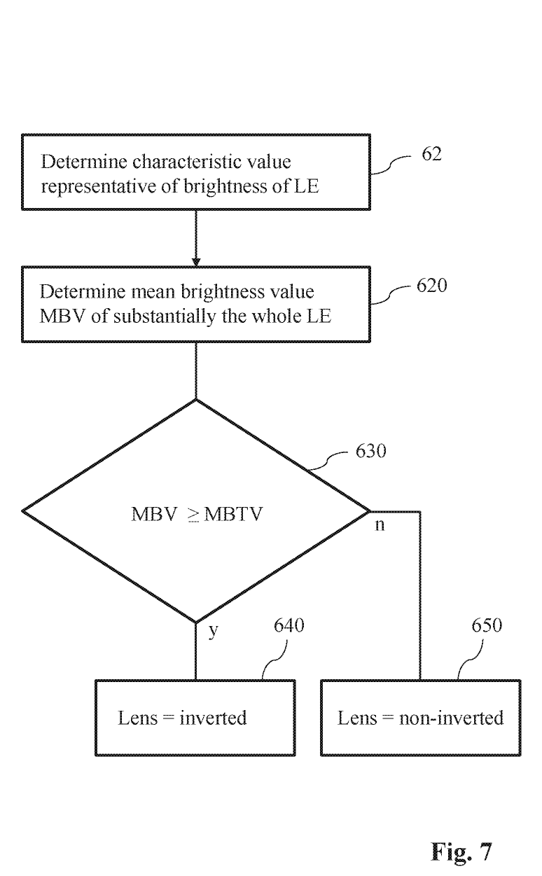

FIG. 7 shows a flow chart representing a first embodiment of some essential steps of the method according to the invention;

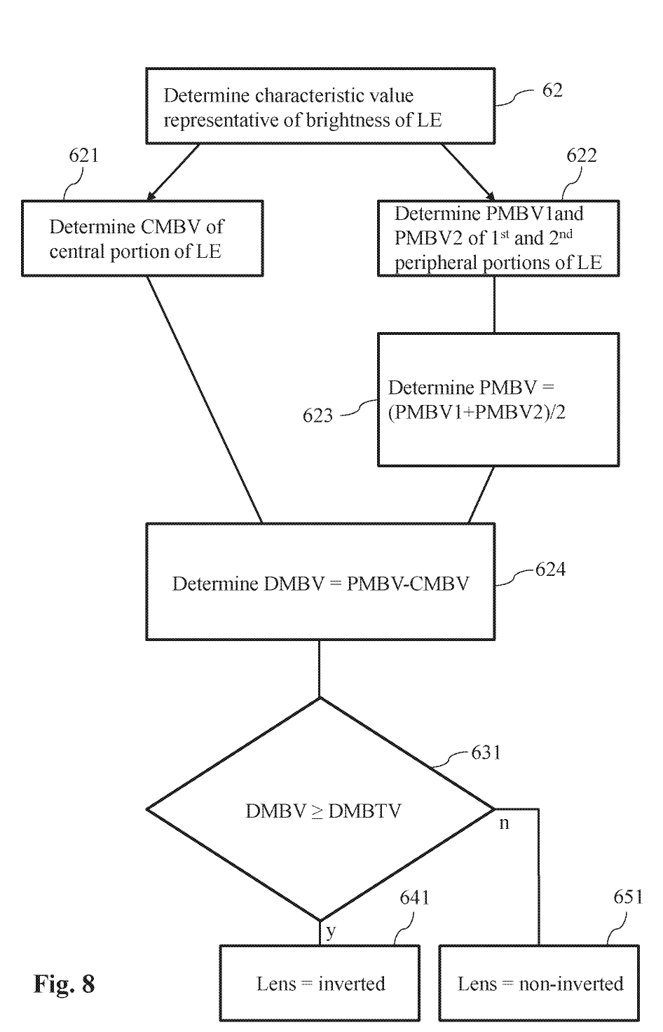

FIG. 8 shows a flow chart representing a second embodiment of some essential steps of the method according to the invention;

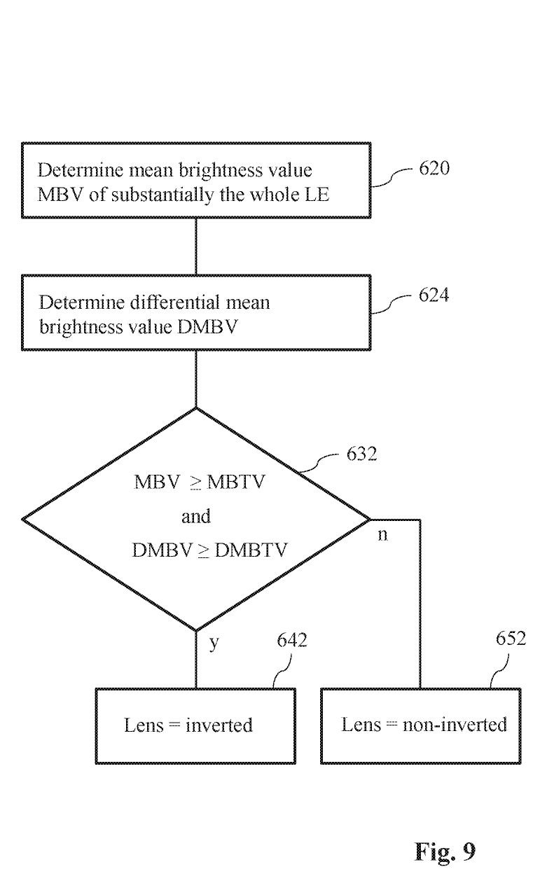

FIG. 9 shows a flow chart representing a third embodiment of some essential steps of the method according to the invention;

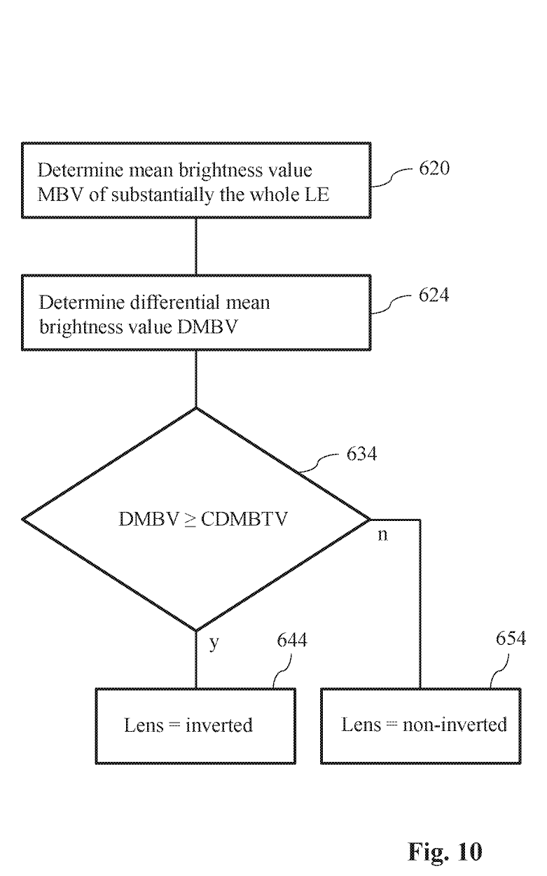

FIG. 10 shows a flow chart representing a fourth embodiment of some essential steps of the method according to the invention;

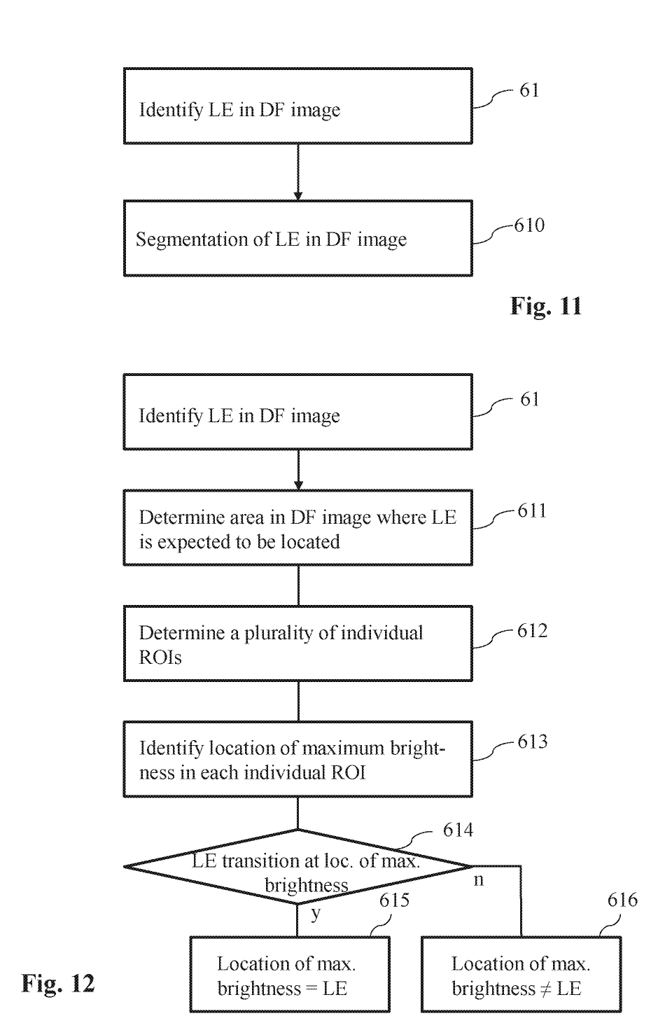

FIG. 11 shows a flow chart representing a first embodiment of how the lens edge is identified in the dark-field image;

FIG. 12 shows a flow chart representing a second embodiment of how the lens edge is identified in the dark-field image;

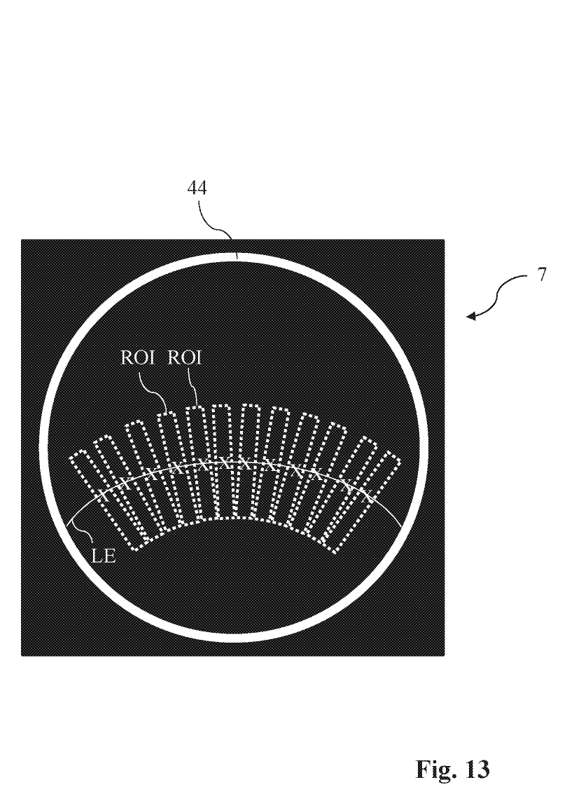

FIG. 13 shows a dark-field image of an inverted soft contact lens schematically illustrating the mode of operation of the embodiment of FIG. 12;

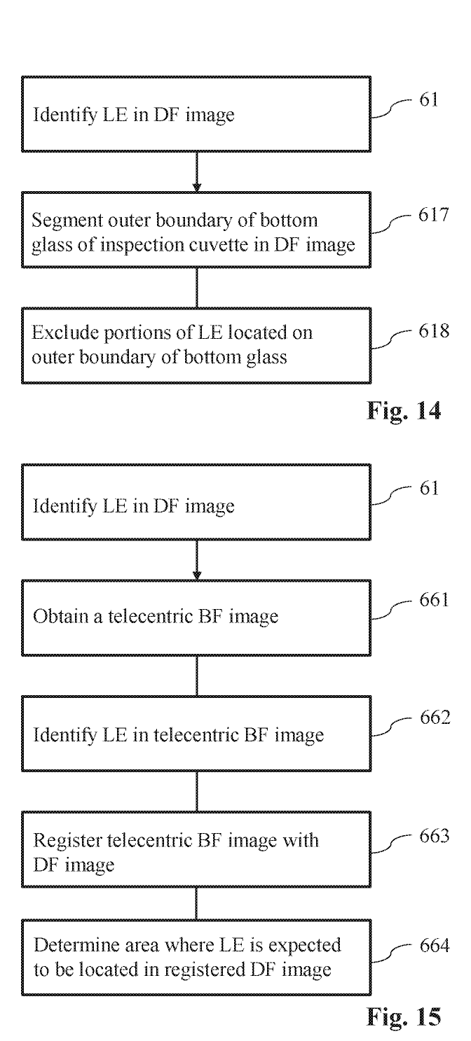

FIG. 14 shows a flow chart representing an embodiment of how the influence of the bottom glass of the inspection cuvette can be eliminated during identification of the lens edge;

FIG. 15 shows a flow chart representing a third embodiment of how the lens edge is identified in the dark-field image;

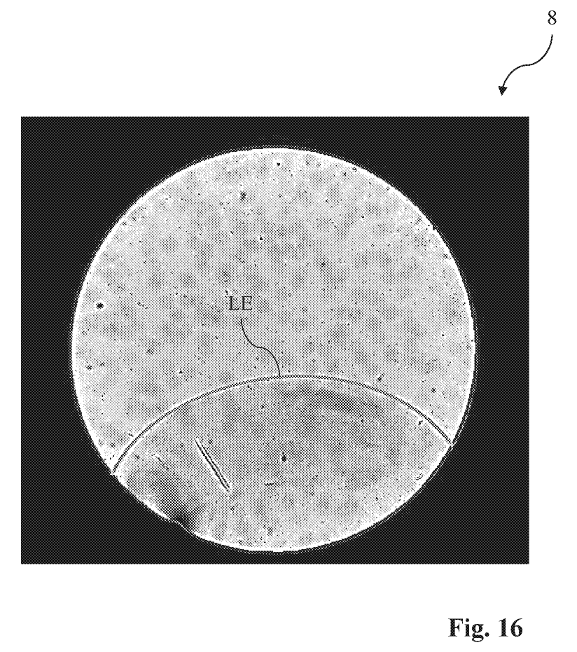

FIG. 16 shows a telecentric bright-field image of an inverted soft contact lens, for use in the third embodiment of FIG. 15;

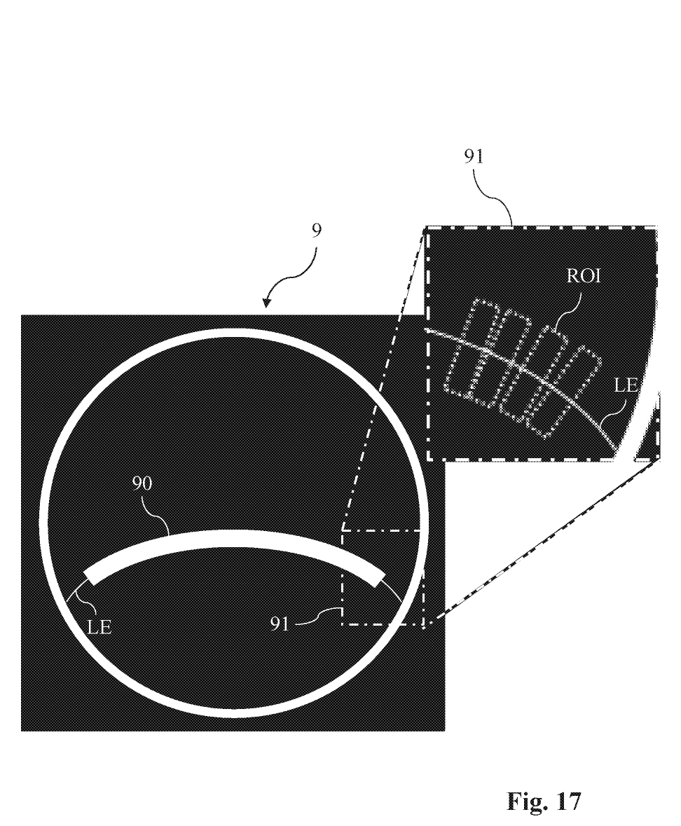

FIG. 17 shows a dark-field image registered with the telecentric bright-field image of FIG. 16, illustrating how the lens edge is identified in the registered dark-field image;

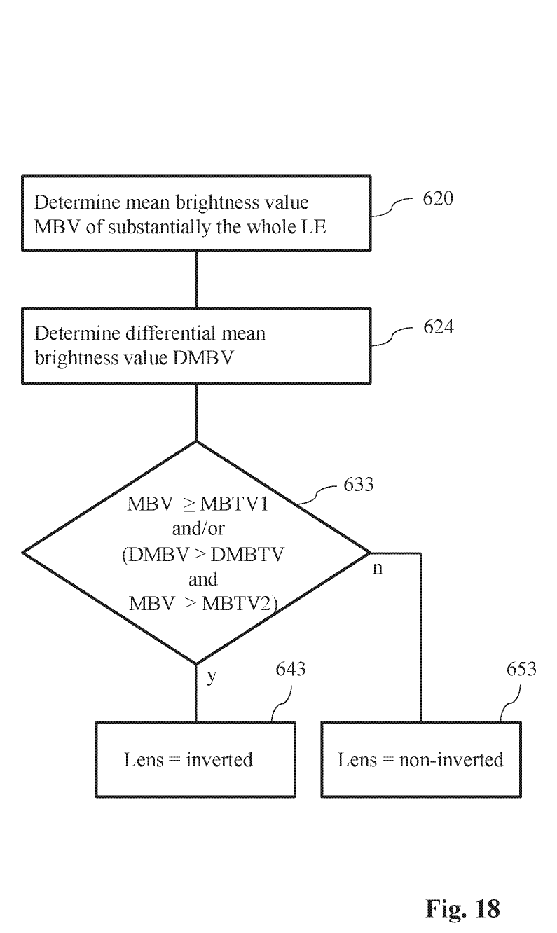

FIG. 18 shows a flow chart illustrating the manner how the inversion state of the soft contact lens is determined in the third embodiment of FIG. 15;

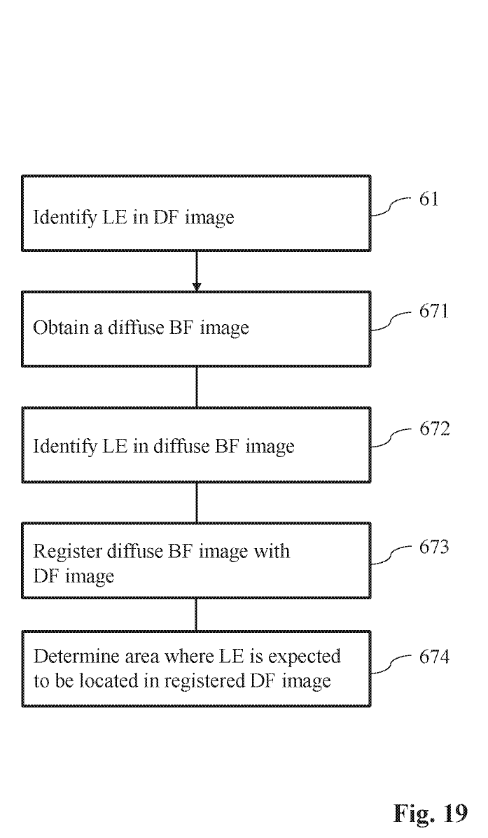

FIG. 19 shows a flow chart representing a fourth embodiment of how the lens is identified in the dark-field image; and

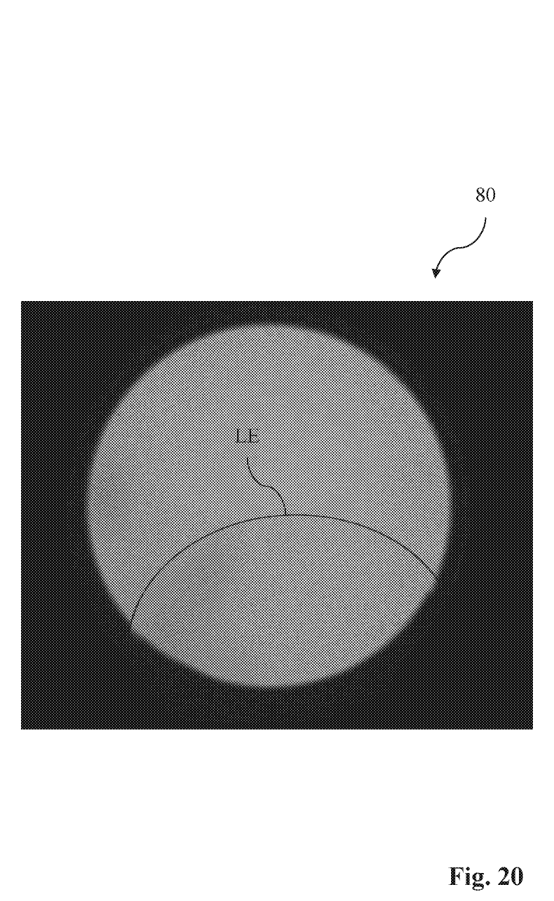

FIG. 20 shows a diffuse bright-field image of an inverted soft contact lens, for use in the fourth embodiment of FIG. 19.

FIG. 1 shows an embodiment of some essential components of an apparatus for carrying out the method according to the invention. A soft contact lens CL to be inspected is contained in an inspection cuvette 1 which is arranged in the handling position, in which the soft contact lens CL can be inserted into and removed from the inspection cuvette 1. Inspection cuvette 1 comprises an interior space 10 which is filled with a liquid L, for example water, in which the soft contact lens CL is immersed. Inspection cuvette 1 comprises a handling channel 11 which is connected at a first end thereof with the interior space 10 of the inspection cuvette 1, and which comprises a handling opening 12 for insertion of the soft contact lens CL into and removal of the soft contact lens CL from the interior space 10 of the inspection cuvette 1. For example, the soft contact lens CL may be inserted into the interior space 10 of the inspection cuvette with the aid of a gripper 2 schematically illustrated in FIG. 1 (for example, this gripper may be a transfer gripper as shown in WO 2012/066060 already mentioned further above). Gripper 2 can be moved in the direction of the double-headed arrow 20 through handling opening 12 and through handling channel 11 to insert the soft contact lens CL into and to remove the soft contact lens CL from the interior space 10 of the inspection cuvette 1 in a manner well-known in the art.

Inspection cuvette 1 further comprises a flat top viewing glass 13 forming an upper boundary of the interior space 10. The flat top viewing glass 13 is arranged such that an optical axis OA running normal to the flat top viewing glass 13 also runs through a center of a concave inner surface 140 of a bottom glass 14 of the inspection cuvette 1.

As mentioned, in FIG. 1 inspection cuvette 1 is shown in the handling position, but is generally pivotally arranged about a pivot axis PA (indicated by a small circle in FIG. 1) between the handling position (shown in FIG. 1) and an inspection position (not shown in FIG. 1) in which the optical axis OA running normal to the top viewing glass 13 and through the center of the concave surface 140 of the bottom glass 14 runs in a vertical direction in the drawing plane of FIG. 1. In the inspection position, the soft contact lens CL is inspected for defects. In addition, in the inspection position, the refractive power and the center thickness of the soft contact lens CL may be determined.

In FIG. 1 a light source 15 is shown which is capable of illuminating the inspection cuvette 10 and the soft contact lens CL contained therein in a dark-field illumination. A camera 16 captures the dark-field image, and in the embodiment shown the camera 16 may also be capable of performing image analysis and image processing functions, although these functions do not have to be an integral part of camera 16 but may be performed by a device other than the camera 16, for example by a computer or other image evaluation unit connected to camera 16 (not shown in FIG. 1).

After inspection of the soft contact lens CL is completed and the soft contact lens CL has successfully passed all inspection steps, the soft contact CL is removed from the inspection cuvette 1 by the gripper 2 and is then typically transferred to and placed into a primary packaging shell for packaging. However, to achieve this transfer after inspection of the soft contact lens CL has been completed, the inspection cuvette 1 must be pivoted about the pivot axis PA once more in order to be arranged in the handling position shown in FIG. 1 again, in which removal of the soft contact lens CL from the interior space 10 of inspection cuvette 1 is possible with the aid of the gripper 2. During this pivotal movement, but also during horizontal transportation of the inspection cuvette 1 (into or out of the drawing plane of FIG. 1), the soft contact lens CL may be swirled up (as is exaggeratedly shown in FIG. 1) and may subsequently settle down again. This may lead to the soft contact lens CL getting inverted. As a consequence, even though in the very last inspection step prior to pivoting the inspection cuvette 1 into the handling position the soft contact lens CL may be in the non-inverted state (which may even be confirmed in the last inspection step), the soft contact lens CL may inadvertently get inverted prior to being removed from the interior space 10 of inspection cuvette 1 and transferred to the primary packaging shell. Such inadvertent inversion of the soft contact lens CL, although generally occurring only rarely, may occur a little more frequently with toric soft contact lenses but may generally occur with all types of soft contact lenses. Of course, as has been mentioned further above there may be other reasons as well why the soft contact lens CL may be in the inverted state at the time of being ready for the transfer to the primary packaging shell (i.e. when the inspection cuvette is in the handling position and ready for the lens transfer). However, as mentioned, an inverted soft contact lens CL in a packaging shell must be avoided (as has been discussed further above), as it at least causes customer dissatisfaction. The invention, therefore, is about reliably determining the inversion state of the soft contact lens CL at the time the inspection cuvette 1 is in the handling position again in which the soft contact lens CL is removed from the inspection cuvette 1 so as to avoid that an inverted soft contact lens is placed into the primary packaging shell.

As can be seen, in FIG. 1 the inspection cuvette containing the contact lens is in the handling position, however, the soft contact lens CL is shown swirled up. In FIG. 2, the soft contact lens CL has settled down again in the non-inverted state, whereas in FIG. 3 the soft contact lens CL has settled down again in the inverted state. In the first case (FIG. 2, soft contact lens CL is in the non-inverted state), the soft contact lens CL is to be removed by the gripper 2 and is to be transferred to and placed into the primary packaging shell. In the second case (FIG. 3, soft contact lens CL is in the inverted state), the soft contact lens CL is either to be removed by the gripper 2 and is to be disposed of (rather than being placed into the primary packaging shell) or is not removed by the gripper 2 from the inspection cuvette 1 at all but instead is sucked from the inspection cuvette 1 together with the water contained in the inspection cuvette 1 during transportation of the inspection cuvette 1 back to the inspection station at which water is filled into the inspection cuvette 1 again for the next soft contact lens CL to be inspected.

Turning back to FIG. 1, the inspection cuvette 1 is in the handling position. Let us assume that the soft contact lens CL has settled down again either in the non-inverted state (FIG. 2) or in the inverted state (FIG. 3). With the aid of the dark-field image captured by camera 16 (FIG. 1) it is now possible to determine the inversion state of the soft contact lens CL (i.e. whether or not the soft contact lens CL contained in the inspection cuvette 1 is inverted) when the inspection cuvette 1 is in the handling position, i.e. immediately prior to the intended removal and transfer of the soft contact lens CL.

FIG. 4 shows a dark-field image 4 of an inverted soft contact lens CL in the inspection cuvette 1 whereas FIG. 5 shows a dark-field image 5 of a non-inverted soft contact lens CL in the inspection cuvette 1. In FIG. 4, the bright white outer circle 44 represents the outer boundary of the bottom glass 14 of the inspection cuvette 1. The dashed segment 45 is not part of the dark-field image, its purpose will be discussed further below. Similarly, in FIG. 5 the bright white outer circle 54 represents the outer boundary of the bottom glass 14 of the inspection cuvette 1, and again the dashed segment 55 is not part of the dark-field image 5.

As can be easily seen when glancing at FIG. 4 and FIG. 5, the brightness of the lens edge LE of the inverted soft contact lens CL shown in FIG. 4 is substantially different from the brightness of the lens edge LE of the non-inverted soft contact lens CL shown in FIG. 5. This difference in brightness of the lens edge LE of an inverted soft contact lens CL is used in the method according to the invention for the determination of whether or not the soft contact lens CL is inverted. And even though this difference in brightness is not always as pronounced as it is shown in FIG. 4 and FIG. 5, it is sufficiently pronounced to be used for the determination of the inversion state of the soft contact lens CL. Embodiments of how this determination is made are described in more detail below.

FIG. 6 shows a flow chart representing some essential steps of the method 6 according to the invention in a general manner. In step 60, a dark-field image of the soft contact lens CL is determined. Next, in step 61 the lens edge LE is identified in the dark-field image of the soft contact lens CL. Thereafter, in step 62 generally one or more characteristic values representative of the brightness of at least a portion of the lens edge LE is/are determined, in the example shown in FIG. 6 in step 62 there is only one such characteristic value. In step 63, this characteristic value is compared with a predetermined threshold value (for this specific characteristic value) as to whether the characteristic value is equal to or above the predetermined threshold value, or is below the predetermined threshold value. In case the determined characteristic value is equal to or above the predetermined threshold value, in step 64 the lens is determined as being inverted. In case the characteristic value is below the predetermined threshold value, in step 65 the soft contact lens CL is determined as being non-inverted. This flow chart represents the general manner how the determination of the inversion state is made, however, different embodiments thereof are described in more detail below.

FIG. 7 shows a flow chart representing a first embodiment of some essential steps of the method according to the invention. In particular, step 62 of FIG. 6 of determining a characteristic value representative of the brightness of at least a portion of the lens edge LE in this embodiment comprises the step 620 of determining a mean brightness value MBV of substantially the whole lens edge LE. Of course, those portions of the lens edge LE which are located on the outer boundary of the bottom glass 14 or portions which may otherwise interfere with the brightness caused by the outer boundary of the bottom glass 14 (bright white outer circle 44 in FIG. 4 or bright white outer circle 54 in FIG. 5) are excluded from the determination of the mean brightness value. Also, portions of the lens edge LE located outside the boundary of the bottom glass 14 are excluded. For the rest of the lens edge LE (i.e. for 'substantially' the whole lens edge) the brightness of the individual pixels located on the lens edge LE is determined, for example as gray scale values, with each individual gray scale value being representative of the brightness of the corresponding individual pixel. The individual gray scale values are added and divided by the total number of individual gray scale values to determine the mean gray scale value (representing the mean brightness value MBV). In step 630, this mean brightness value MBV is then compared with a predetermined mean brightness threshold value MBTV. In case the mean brightness value MBV is equal to or above the predetermined mean brightness threshold value MBTV, in step 640 the soft contact lens CL is determined as being inverted. In case the mean brightness value MBV is lower than the predetermined mean brightness threshold value MBTV, then in step 650 the soft contact lens CL is determined as being non-inverted.

FIG. 8 shows a flow chart representing a second embodiment of some essential steps of the method according to the invention. In particular, step 62 of FIG. 6 of determining a characteristic value representative of the brightness of at least a portion of the lens edge LE in this embodiment comprises a plurality of steps that will be discussed in the following. In a step 621 a central mean brightness value CMBV representative of the brightness of a central portion of the lens edge LE is determined. In addition, in step 622 a first peripheral mean brightness value PMBV1 representative of the brightness of a first peripheral portion of the lens edge LE is determined, as well as a second peripheral mean brightness value PMBV2 representative of the brightness of a second peripheral portion of the lens edge LE. The first peripheral portion of the lens edge LE and the second peripheral portion of the lens edge LE are located on opposite sides of the central portion of the lens edge LE. Determination of the central mean brightness value CMBV, the first peripheral mean brightness value PMBV1 and the second peripheral mean brightness value PMBV2 can be performed in the same manner as has been described above for the mean brightness value MBV of substantially the whole lens edge LE (i.e. by adding individual gray scale values and dividing the sum of the individual gray scale values by the total number of individual gray scale values). Thereafter, in step 623 the first peripheral mean brightness value PMBV1 and the second peripheral mean brightness value PMBV2 are averaged to determine a (common) peripheral mean brightness value PMBV. Determination of the peripheral mean brightness value may be performed, for example, by adding the first peripheral mean brightness value PMBV1 and the second peripheral mean brightness value PMBV2 and dividing the so obtained value by two. Thereafter, in step 624 a differential mean brightness value DMBV is determined by subtracting the central mean brightness value CMBV from the peripheral mean brightness value PMBV. In step 631, the so obtained differential mean brightness value DMBV is then compared with a predetermined differential mean brightness threshold value DMBTV. In case the differential mean brightness value DMBV is equal to or above the predetermined differential mean brightness threshold value DMBTV, the soft contact lens CL is determined as being inverted in step 641. In case the differential mean brightness value DMBV is lower than the predetermined differential mean brightness threshold value, the soft contact lens is determined as being non-inverted in step 651.

Of course, in a third embodiment the determination of the orientation of the soft contact lens (inverted or non-inverted) may also be made based on both determinations described above. FIG. 9 shows a flow chart of a third embodiment of some essential steps of the method according to the invention. The third embodiment comprises the step 620 of determining the mean brightness value MBV of substantially the whole lens edge LE (like in FIG. 7), and in addition comprises the step 624 of determining the differential mean brightness value DMBV (like in FIG. 8). Unlike in FIG. 7 and FIG. 8, in the third embodiment it may then be determined in step 632 whether both the mean brightness value MBV is equal to or above the predetermined mean brightness threshold value MBTV and the differential mean brightness value DMBV is equal to or above the predetermined differential mean brightness threshold value DMBTV. Only in case both the mean brightness value MBV is equal to or above the mean brightness threshold value and the differential mean brightness value DMBV is equal to or above the differential mean brightness threshold value DMBTV, then the soft contact lens CL is determined in step 642 as being inverted. Otherwise, the soft contact lens CL is determined in step 652 as being non-inverted.

FIG. 10 shows a flow chart of a fourth embodiment of some essential steps of the method according to the invention. Similar to the third embodiment described above with respect to FIG. 9, the fourth embodiment comprises the step 620 of determining the mean brightness value MBV of substantially the whole lens edge LE (like in FIG. 7), and in addition comprises the step 624 of determining the differential mean brightness value DMBV (like in FIG. 8). Unlike in FIG. 9, in the fourth embodiment it may then be determined in step 634 whether the differential mean brightness value DMBV is equal to or above a predetermined combined differential mean brightness threshold value CDMBTV. This predetermined combined differential mean brightness threshold value CDMBTV linearly depends from the determined mean brightness value MBV of substantially the whole lens edge. Or to say it in other words: The graph of the predetermined combined differential mean brightness threshold value CMBDTV in an x-y diagram in which the differential mean brightness value DMBV is shown on the ordinate y and in which the mean brightness value MBV is shown on the abscissa x is a straight line having a predetermined slope. The lower the value for the mean brightness value MBV is (i.e. the lower the mean brightness of the lens edge in the dark-field image is), the higher is the predetermined combined differential mean brightness threshold value CDMBTV (i.e. the larger the difference between the mean brightness of the peripheral portions of the lens edge from the mean brightness of the central portion of the lens edge must be). In this fourth embodiment, only one comparison with a threshold must be performed, namely the comparison of the (actual) determined differential mean brightness value DMBV with the predetermined combined differential mean brightness threshold value CDMBTV, however, this threshold value CDMBTV to which the (actual) determined differential mean brightness value DMBV is to be compared depends on the (actual) determined mean brightness value MBV. In case the differential mean brightness value DMBV is equal to or above the combined differential mean brightness threshold value CDMBTV, the soft contact lens CL is determined in step 644 as being inverted. Otherwise, the soft contact lens CL is determined in step 654 as being non-inverted.

FIG. 11 shows a flow chart representing a first embodiment of how the lens edge LE is identified in the dark-field image. In this embodiment, the step 61 of identifying the lens edge LE in the dark-field image (see FIG. 6) comprises the step 610 of segmentation of the lens edge in the dark-field image. Suitable segmentation techniques are known in the art. With the aid of segmentation techniques not all portions of the dark-field image have to be analyzed (and the related data processed), but rather portions of the dark-field image which are in the region of the lens edge must be analyzed (and the corresponding data processed) only. As shown in FIG. 4 and FIG. 5 a very coarse segmentation is represented by the dashed line 45 (FIG. 4) and the dashed line 55 (FIG. 5) which excludes, for example, the outer boundary 44 (FIG. 4) and 54 (FIG. 5) of the bottom glass 14 of the inspection cuvette. Of course, other and even more accurate segmentation methods are known in the art.

FIG. 12 shows a flow chart representing a second embodiment of how the lens edge LE is identified in the dark-field image, and FIG. 13 shows a dark-field image 7 of an inverted soft contact lens CL schematically illustrating the mode of operation of the second embodiment of FIG. 12. According to this second embodiment the step 61 (FIG. 6) of identifying the lens edge LE comprises the step 611 of determining an area where the lens edge LE is expected to be located. This area may be determined based on the geometry of the inspection cuvette 1 taking into account that the inspection cuvette 1 is in the handling position shown in FIG. 1 - FIG. 3, and further taking into account that the soft contact lens CL has come to rest on the concave inner surface 140 of the bottom glass 14, as is schematically shown in FIG. 2 and FIG. 3. Next, in step 612 a plurality of individual regions of interest ROI are identified in the said area where the lens edge LE is expected to be located. In FIG. 13, this area where the lens edge LE is expected to be located generally has the shape of a fan, and this fan comprises the plurality of individual regions of interest ROI each of which has the shape of a rectangle. The longitudinal sides of the individual rectangles extend in the radial direction of the fan. Turning back to FIG. 12, in step 613 for each of the individual region of interest ROI (rectangles in FIG. 13) the location of maximum brightness is determined. Again, the individual levels of brightness in such region of interest ROI can be represented as gray scale values. The location of maximum brightness within each region of interest ROI (here: within each of the rectangles) is marked with a white X in FIG. 13 and represents a pixel of the lens edge LE in the dark-field image 7. Turning back to FIG. 12, in step 614 it is then determined whether there is a lens edge transition at the location of maximum brightness X in the respective region of interest ROI. Whether or not there is a lens edge transition is detected if the next pixels in the radial direction within the respective region of interest ROI (i.e. those pixels which are radially adjacent to the location of maximum brightness X) are substantially darker (i.e. the brightness of these next pixels in the radial direction is more than 25% less than the brightness at the location of maximum brightness X). Detection of a lens edge transition at the location of maximum brightness in the individual region of interest ROI additionally confirms that the location of maximum brightness is actually a pixel located on the lens edge LE in the dark-field image 7 of the soft contact lens CL (since there is a substantial change in brightness in the radial direction adjacent to the lens edge LE). In such instance, in step 615 it is determined that the location of maximum brightness is a location on the lens edge LE, otherwise in step 616 it is determined that the location of maximum brightness is not a location on the lens edge. Of course, in practice it is also possible that the pixels in radial direction which are taken into consideration when determining whether or not there is a lens edge transition may comprise a predetermined number of pixels in the radial direction (in each of the radial inner direction and the radial outer direction). In such case, from this plurality of pixels that pixel is associated to the lens edge the location of which is closest to the center of the region of interest ROI.

Also, in the dark-field image 7 segmentation of the outer boundary of the bottom glass 14 of the inspection cuvette 1 may be performed first, so that any portions of the lens edge LE located on said outer boundary 44 are excluded. This is shown in FIG. 14. In step 617, the outer boundary 44 of the bottom glass of the inspection cuvette in the dark-field image 7 is segmented. In step 618, the portions of the lens edge LE that are located on the outer boundary 44 of the bottom glass are excluded to prevent any falsification of the determination of the inversion state of the soft contact lens.

Identifying the lens edge LE as described above may be combined with any kind of determination of the inversion state of the soft contact lens. In particular, it may be combined with the afore-described embodiments of the method for determining the inversion state.

To determine the inversion state of the soft contact lens, by way of example a number of one hundred regions of interest ROI may be arranged along an angular segment of the fan between 30° and 150° (in FIG. 13 much less than one hundred regions of interest ROI are shown for illustrative purposes), and the first thirty individual regions of interest ROI as well as the last thirty regions of interest ROI from these one hundred regions of interest ROI are taken to determine the first peripheral mean brightness value PMBV1 and the second peripheral mean brightness value PMBV2 (see FIG. 8 above). That is, the maximum brightness at each of the locations of maximum brightness within each of these thirty individual regions of interest ROI is taken and is summed up. The sum is then divided by thirty to determine the first peripheral mean brightness value PMBV1 and the second peripheral mean brightness value PMBV2. The first peripheral mean brightness value PMBV1 and the second peripheral mean brightness value PMBV2 are then summed up, and the result of the sum is divided by two so as to obtain the (common) peripheral mean brightness value PMBV.

For the centrally located forty regions of interest ROI of the afore-mentioned one hundred regions of interest ROI, the maximum brightness at each of the locations of maximum brightness in these forty regions of interest ROI is summed up, and the sum is then divided by forty to obtain the central mean brightness value CMBV. Thereafter, as is described in FIG. 8, the central mean brightness value CMBV is subtracted from the peripheral mean brightness value PMBV to obtain the differential mean brightness value DMBV. This differential mean brightness value DMBV is then compared with the predetermined differential mean brightness threshold value DMBTV or with the combined differential mean brightness threshold value CDMBTV to determine whether or not the soft contact lens is inverted.

Also, using the afore-mentioned one hundred individual regions of interest ROI it is possible to determine the mean brightness value MBV of substantially the whole lens edge LE (see FIG. 7) by summing up the maximum brightness at each of the locations of maximum brightness within these one hundred regions of interest ROI, and by then dividing the result of the sum by one hundred. The mean brightness value MBV is then compared with a predetermined mean brightness threshold value MBTV to determine whether or not the soft contact lens is inverted.

As already mentioned above, all embodiments of determining the inversion state of the soft contact lens (differential mean brightness value; mean brightness value of substantially the whole lens edge) may be performed, and in case at least one of these determinations leads to the result that the soft contact lens is inverted, then it is determined that the soft contact lens is inverted.

FIG. 15 shows a flow chart representing a third embodiment of how the lens edge LE is determined in the dark-field image. This third embodiment is substantially different from the embodiments described above in that the step 61 of identifying the lens edge LE comprises a step 661 of obtaining a telecentric bright-field image of the soft contact lens. A telecentric bright-field image 8 of an inverted soft contact lens is shown FIG. 16. It is immediately evident that the lens edge LE can be easily identified in the telecentric bright-field image 8, as is indicated by step 662 in FIG. 14. Suitable techniques for identifying the lens edge LE in the telecentric bright-field image 8 can be used for this purpose, for example segmentation techniques. However, to be able to make use of the positional information of the lens edge LE of the telecentric bright-field image 8 for the analysis of the dark-field image, in particular as regards the expected location of the lens edge LE in the dark-field image (similar to step 611 in FIG. 12), the telecentric bright-field image 8 and the corresponding dark-field image (for example the dark-field image 7 shown in FIG. 13) of the soft contact lens must be registered, as this is indicated by step 663 in FIG. 15. After registration of the telecentric bright-field image and the dark-field image the area where the lens edge LE is expected to be located can be determined more accurately, so that the amount of data of the dark-field image which need to be processed can be further reduced, as this is indicated by step 664 in FIG. 15.

This can be seen in the registered dark-field image 9 shown in FIG. 17 in which the area where the lens edge LE is expected to be located is indicated by the curved section 90. This curved section is comparatively small in width, and this means that only the data of this small curved section 90 of the registered dark-field image have to be analyzed in more detail. A detail 91 of the dark-field image 9 comprising a portion of this curved section 90 is shown in FIG. 17 exaggeratedly large. In this enlarged detail 91 the lens edge LE as well as the individual regions of interest ROI are schematically indicated, however, the extension of the regions of interest ROI in the radial direction corresponds to the small width of the curved section 90 in this embodiment so that the amount of data to be analyzed in order to determine the location of maximum brightness within the respective region of interest ROI is greatly reduced.

While generally any kind of determining the inversion state of the soft contact lens is conceivable, a flow chart is shown in FIG. 18 illustrating the manner how the inversion state of the soft contact lens may be determined in the third embodiment of how the lens edge is determined as shown in FIG. 15 (telecentric bright-field image and dark-field image). To determine the inversion state of the soft contact lens, according to step 620 in the registered dark-field image the mean brightness value MBV of substantially the whole lens edge LE may be determined (as has been described in detail above already) Also, according to step 624 the differential mean brightness value DMBV may be determined in the manner already described above.

According to step 633 it is then determined whether the mean brightness value MBV is equal to or above a predetermined first mean brightness threshold value MBTV1. Also, it is determined whether the differential mean brightness value DMBV is equal to or above a predetermined differential mean brightness threshold value DMBTV while at the same time the mean brightness value MBV is equal to or above a second mean brightness threshold value MBTV2 lower than the first mean brightness threshold value MBTV1. In case one of the afore-mentioned conditions is fulfilled (or both conditions are fulfilled), the soft contact lens is determined as being inverted in step 643. In case none of the conditions is fulfilled, the soft contact lens is determined as being non-inverted in step 653.

FIG. 19 shows a flow chart representing a fourth embodiment of how the lens edge LE is determined in the dark-field image. This fourth embodiment essentially corresponds to the third embodiment (see FIG. 15), but differs therefrom in that instead of the telecentric bright-field image 8 (see FIG. 16) a diffuse bright-field image is obtained, as is indicated at step 671. A diffuse bright-field image 9 of an inverted soft contact lens is shown FIG. 20. It is immediately evident that the lens edge LE can be easily identified in the diffuse bright-field image 9, as is indicated by step 672 in FIG. 19. Suitable techniques for identifying the lens edge LE in the diffuse bright-field image 9 can be used for this purpose, for example segmentation techniques. However, to be able to make use of the positional information of the lens edge LE of the diffuse bright-field image 9 for the analysis of the dark-field image, in particular as regards the expected location of the lens edge LE in the dark-field image (similar to step 611 in FIG. 12), the diffuse bright-field image 9 and the corresponding dark-field image (for example the dark-field image 7 shown in FIG. 13) of the soft contact lens must be registered, as this is indicated by step 673 in FIG. 19. After registration of the diffuse bright-field image and the dark-field image the area where the lens edge LE is expected to be located can be determined more accurately, so that the amount of data of the dark-field image which need to be processed can be further reduced, as this is indicated by step 674 in FIG. 19.

Having described embodiments of the invention with the aid of examples shown in the drawings, many changes and modifications to the described embodiments are possible without departing from the teaching underlying the instant invention. For example, in most of the embodiments described only one characteristic value representative of the brightness of a portion of the lens edge (or the whole lens edge or substantially the whole lens edge) is determined and compared with a corresponding predetermined threshold value (specific for that one characteristic value). However, it is also possible to determine more than one such characteristic value. In such instance, either a single one characteristic value of these more than one characteristic values may be considered and compared with a (corresponding) predetermined threshold value, or more than one (or even all) of these more than one characteristic values may be considered and compared with their (corresponding) threshold values in determining whether or not the soft contact lens is inverted. In such instance, the soft contact lens may be determined as being inverted if only one such characteristic value (of these more than one characteristic values) is above or below its (corresponding) predetermined threshold value, or the soft contact lens may be determined as being inverted in case a specific combination of these (more than one) characteristic values are above/below their (corresponding) predetermined threshold values, or the soft contact lens may be determined as being inverted if all of these (more than one) characteristic values are above/below their (corresponding) predetermined threshold values. The scope of protection is therefore defined by the appended claims.

1. Method for determining the inversion state of a soft contact lens (CL) which is arranged in an interior space (10) of an inspection cuvette (1) and which is immersed in a liquid (L) contained in the interior space (10) of the inspection cuvette (1), the inspection cuvette (1) being pivotally arranged about a pivot axis (PA) for being positioned either in an inspection position in which the soft contact lens (CL) is inspected, or in a handling position in which the soft contact lens (CL) can be inserted into and removed from the interior space (10) of the inspection cuvette (1), the inspection cuvette (1) comprising:
- a bottom glass (14) forming a lower boundary of the interior space (10), the bottom glass (14) having a concave inner surface (140) for the soft contact lens (CL) to rest on, the concave inner surface (140) facing towards the interior space (10); - a flat top viewing glass (13) forming an upper boundary of the interior space (10), the flat top viewing glass (13) being arranged such that an optical axis (OA) running normal to the flat top viewing glass (13) runs through the center of the concave inner surface (140) of the bottom glass (14); - a handling channel (11) which is connected at a first end thereof with the interior space (10), and at a second end thereof comprises a handling opening (12) for insertion of the soft contact lens (CL) into and removal of the soft contact lens (CL) from the interior space (10) through the handling opening (12) and the handling channel (11); the method comprising the steps of: - positioning the inspection cuvette (1) in the handling position; - through the viewing glass (13) obtaining (60) a dark-field image (4,5,7,9) of the soft contact lens (CL) arranged in the interior space (10) along the optical axis (OA); - identifying (61) a lens edge (LE) of the soft contact lens (CL) in the dark-field image (4,5,7,9); - determining (62) one or more characteristic values representative of the brightness of at least a portion of the lens edge (LE) in the dark-field image (4, 5, 7, 9); - comparing (63) at least one of the one or more characteristic values with a corresponding predetermined threshold value; and - determining (64) that the soft contact lens (CL) is inverted in case the at least one of the one or more characteristic values is equal to or above the corresponding predetermined threshold value; or - determining (65) that the soft contact lens (CL) is not inverted in case the at least one of the one or more characteristic values is below the corresponding predetermined threshold value.

2. Method according to claim 1, wherein the step (62) of determining the one or more characteristic values representative of the brightness of at least a portion of the identified lens edge in the dark-field image comprises determining (620) a mean brightness value (MBV) of substantially the whole lens edge (LE) in the dark-field image (4,5,7,9), and wherein the step of comparing (63) the at least one of the one or more characteristic values with a corresponding predetermined threshold value comprises comparing (630,632,633) the mean brightness value (MBV) with a predetermined mean brightness threshold value (MBTV,MBTV1,MBTV2).

3. Method according to claim 1,
wherein the step of determining (62) the one or more characteristic values representative of the brightness of at least a portion of the lens edge (LE) in the dark-field image comprises
determining (621) a central mean brightness value (CMBV) of a central portion of the lens edge (LE); - determining (622) a first peripheral mean brightness value (PMBV1) of a first peripheral portion of the lens edge (LE) and a second peripheral mean brightness value (PMBV2) of a second peripheral portion of the lens edge (LE), the first peripheral portion and the second peripheral portion being located at opposite sides of the central portion of the lens edge (LE);- determining (623) a peripheral mean brightness value (PMBV) by averaging the first peripheral mean brightness value (PMBV1) and the second peripheral mean brightness value (PMBV2), and - determining (624) a differential mean brightness value (DMBV) by subtracting the central mean brightness value (CMBV) from the peripheral mean brightness value (PMBV); and wherein the step of comparing (63) the at least one of the one or more characteristic values with a corresponding predetermined threshold value comprises - comparing (631) the differential mean brightness value (DMBV) with a predetermined differential mean brightness threshold value (DMBTV).

4. Method according to claim 2 , wherein both the mean brightness value (MBV) of substantially the whole lens edge (LE) in the dark-field image as well as the differential mean brightness value (DMBV) are determined and compared (632) with the predetermined mean brightness threshold value (MBTV) and the predetermined differential mean brightness threshold value (DMBTV), respectively, and wherein the soft contact lens (CL) is determined as being inverted in case either the mean brightness value (MBV) of substantially the whole lens edge (LE) is equal to or above the predetermined mean brightness threshold value (MBTV) or the differential mean brightness value (DMBV) is equal to or above the predetermined differential mean brightness threshold value (DMBTV), or both.

5. Method according to claim 1,
wherein the step (62) of determining the one or more characteristic values representative of the brightness of at least a portion of the identified lens edge in the dark-field image comprises determining (620) a mean brightness value (MBV) of substantially the whole lens edge (LE) in the dark-field image (4,5,7,9),
and wherein the step of determining (62) the one or more characteristic values representative of the brightness of at least a portion of the lens edge (LE) in the dark-field image further comprises - determining (621) a central mean brightness value (CMBV) of a central portion of the lens edge (LE); - determining (622) a first peripheral mean brightness value (PMBV1) of a first peripheral portion of the lens edge (LE) and a second peripheral mean brightness value (PMBV2) of a second peripheral portion of the lens edge (LE), the first peripheral portion and the second peripheral portion being located at opposite sides of the central portion of the lens edge (LE);- determining (623) a peripheral mean brightness value (PMBV) by averaging the first peripheral mean brightness value (PMBV1) and the second peripheral mean brightness value (PMBV2), and - determining (624) a differential mean brightness value (DMBV) by subtracting the central mean brightness value (CMBV) from the peripheral mean brightness value (PMBV); and wherein the step of comparing (63) the at least one of the one or more characteristic values with a corresponding predetermined threshold value comprises - comparing (634) the determined differential mean brightness value (DMBV) with a predetermined combined differential mean brightness threshold value (CDMBTV) which is linearly dependent from the determined mean brightness value (MBV).

6. Method according claim 5, wherein the step of identifying (61) the lens edge (LE) of the soft contact lens in the dark-field image comprises segmentation (610) of the lens edge in the dark-field image.

7. Method according to claim 1, wherein the step of identifying (61) the lens edge (LE) in the dark-field image comprises determining (611) an area in the dark-field image where the lens edge (LE) is expected to be located, and further comprises determining (612) in the said area where the lens edge is expected to be located a plurality of individual regions of interest (ROI) for each of which the location (X) of maximum brightness within the respective individual region of interest (ROI) is determined, the location (X) of maximum brightness within the respective individual region of interest (ROI) representing a pixel of the lens edge (LE) in the dark-field image.

8. Method according to claim 7, wherein the area in the dark-field image where the lens edge (LE) is expected to be located has the shape of a fan, the fan comprising a plurality of rectangles arranged side by side in a manner such that the longitudinal sides of the individual rectangles of the plurality of rectangles extend in a radial direction of the fan, each of the individual rectangles of the plurality of rectangles representing a said individual region of interest (ROI).

9. Method according to claim 8, wherein the location (X) of maximum brightness within the respective individual rectangle representing the individual region of interest (ROI) is determined to represent a pixel of the lens edge (LE) only in case a lens edge transition is detected within the individual rectangle in the radial direction adjacent to the location (X) of maximum brightness representing the pixel of the lens edge (LE).

10. Method according to claim 1, further comprising the steps of
segmenting (617) the outer boundary (44, 54) of the bottom glass (14) of the inspection cuvette (1) in the dark-field image, and
excluding (618) from the determination of the one or more characteristic values representative of the brightness of the at least one portion of the lens edge (LE) in the dark-field image all portions of the lens edge (LE) which are located on the outer boundary (44, 54) of the bottom glass (14) of the inspection cuvette.

11. Method according to claim 7, further comprising the steps of
through the viewing glass (13) obtaining (661) a telecentric bright-field image (8) of the soft contact lens arranged in the interior space (10) along the optical axis (OA);
identifying (662) the lens edge (LE) of the soft contact lens in the telecentric bright-field image (8);
registering (663) the telecentric bright-field image of the soft contact lens and the dark-field image of the soft contact lens;
in the registered dark-field image (9) of the soft contact lens determining (664) the area (90) where the lens edge (LE) is expected to be located by determining the plurality of individual regions of interest (ROI) at those locations in the dark-field image that correspond to the locations in the registered telecentric bright-field image where the lens edge (LE) of the soft contact lens has been identified.

12. Method according to claim 11, wherein the step of identifying the lens edge (LE) of the soft contact lens in the telecentric bright-field image comprises segmentation of the lens edge (LE) in the telecentric bright-field image.

13. Method according to claim 11,
wherein the step of determining the one or more characteristic values representative of the brightness of at least a portion of the identified lens edge in the dark-field image comprises - determining (620) a mean brightness value (MBV) of substantially the whole lens edge (LE) in the dark-field image, and wherein the step of comparing at least one of the one or more characteristic values with the corresponding predetermined threshold value comprises comparing the mean brightness value (MBV) with a first predetermined mean brightness threshold value (MBTV1); wherein the step of determining the one or more characteristic values representative of the brightness of at least a portion of the lens edge (LE) in the dark-field image further comprises - determining a central mean brightness value (CMBV) of a central portion of the lens edge (LE); - determining a first peripheral mean brightness value (PMBV1) of a first peripheral portion of the lens edge (LE) and a second peripheral mean brightness value (PMBV2) of a second peripheral portion of the lens edge (LE), the first peripheral portion and the second peripheral portion being located at opposite sides of the central portion of the lens edge; - determining a peripheral mean brightness value (PMBV) by averaging the first peripheral mean brightness value (PMBv1) and the second peripheral mean brightness value (PMBV2), and - determining a differential mean brightness value (DMBV) by subtracting the central mean brightness value (CMBV) from the peripheral mean brightness value (PMBV); and wherein the step of comparing (633) the at least one of the one or more characteristic values with the corresponding predetermined threshold value comprises - comparing the differential mean brightness value (DMBV) with a predetermined differential mean brightness threshold value (DMBTV); and wherein the soft contact lens is determined as being inverted in case - either the mean brightness value (MBV) of substantially the whole lens edge is equal to or above the predetermined first mean brightness threshold value (MBTV1), - or the mean brightness value (MBV) of substantially the whole lens edge is equal to or above a predetermined second mean brightness threshold value (MBTV2) lower than the first predetermined mean brightness threshold value (MBTV1) and the differential mean brightness value (DMBV) is equal to or above the predetermined differential mean brightness threshold value (DMBTV), - or both.

14. Method according to claim 7, further comprising the steps of
through the viewing glass (13) obtaining (671) a diffuse bright-field image (80) of the soft contact lens arranged in the interior space (10) along the optical axis (OA);
identifying (672) the lens edge (LE) of the soft contact lens in the diffuse bright-field image (80);
registering (673) the diffuse bright-field image of the soft contact lens and the dark-field image of the soft contact lens;
in the registered dark-field image (80) of the soft contact lens determining (674) the area (90) where the lens edge (LE) is expected to be located by determining the plurality of individual regions of interest (ROI) at those locations in the dark-field image that correspond to the locations in the registered diffuse bright-field image where the lens edge (LE) of the soft contact lens has been identified.

15. Method according to claim 1, wherein the soft contact lens (CL) is a toric soft contact lens, in particular a toric soft contact lens having a posterior surface having a toric geometry and having an anterior surface comprising features for rotationally stabilizing the soft contact lens on the eye at a predetermined orientation.
